(19) United States
(12) Patent Application Publication
(10) Pub. No.: US 2006/0262923 A1
(43) Pub. Date: Nov. 23, 2006

(54) Communication networks that include a high pass filter circuit for connecting communications wiring at a customer premises location to an outside plant loop and methods of operating the same

(76) Inventors: Gary Tennyson, Pelham, AL (US); Henry J. Kafka, Atlanta, GA (US); William L. Smith, Marietta, GA (US)

Correspondence Address: MYERS BIGEL SIBLEY & SAJOVEC, P.A., P.O. BOX 37428, RALEIGH, NC, 27627, US

(21) Appl. No.: 11/294,145

(22) Filed: Dec. 5, 2005

Related U.S. Application Data
(60) Provisional application No. 60/682,786, filed on May 19, 2005.

(51) Int. Cl. H04M 1/00

(52) U.S. Cl. 379/399.01

(57) ABSTRACT

Communications wiring at a customer premises location is connected to an outside plant loop using a high pass filter circuit.

### RELATED APPLICATION

This application claims the benefit of and priority to U.S. Provisional Patent Application No. 60/682,786, filed May 19, 2005, the disclosure of which is hereby incorporated herein by reference as if set forth in its entirety.

### FIELD OF THE INVENTION

The present invention relates to communication networks, and, more particularly, to Voice over Internet Protocol (VoIP)/Voice over Network (VoN) communication networks.

### BACKGROUND OF THE INVENTION

Internet telephony, also referred to herein as Voice-Over Internet Protocol (VoIP), Voice-Over Network (VoN), and/or Internet Protocol Telephony (IP Telephony), is becoming increasingly popular due, in part, to marked improvements in reliability and sound quality of the service. The improved performance of Internet telephony communications may be due to upgrades made to the Internet backbone through improved switching fabrics, such as Asynchronous Transfer Mode (ATM) fabrics, and to implementation of new communications standards, such as standards for transport protocols, directory services, and/or audio codec format.

Currently, to provide Internet telephony communications to a customer, a customer obtains equipment, such as Integrated Access Devices (IADs), Analog Terminal Adaptors (ATAs), telephone adapters (TAs), and the like, to be installed at the customer's premises, for example, a customer's home. The equipment is used to support a voice path within the premises and through a broadband connection, for example, a digital subscriber line (DSL) connection, back to an Internet Service Provider (ISP). Once the necessary equipment is installed, customers/subscribers can connect their existing analog phones, for example, Plain Old Telephone Service (POTS) phones, to the ATA(s). The ATA(s) provide such functionality as dial tone, battery, and power ringing as part of providing POTS functionality through the VoN service. Normally, a Central Office (CO) switch provides dial tone, battery, and power ringing for analog phones.

Thus, a customer may wish to connect all existing analog phones in the customer's premises to an ATA so that the customer's POTS functionality is provided as part of the VoN service. This is illustrated, for example, in FIG. 1 where a communication network 100 is shown that includes a central office 110 that is connected to a network interface device (NID) 120 via an outside plant local loop 130. The NID, which is sometimes referred to as a network interface unit (NIU), serves as a point of demarcation between the local exchange carrier network and the customer's premise. The NID 120 may be a multi-functional device that includes a protector circuit to protect customer premise equipment from high-voltage surges. The NID 120 may also include functionality that allows the central office 110 to perform a loop-back test to check the integrity of the local loop 130. The local loop 130 may be a DSL line, which may provide broadband speeds over a conventional copper loop.

In addition to the NID 120, the customer premises includes customer premises wiring 140, an ATA 150, a DSL modem 160, and a battery 170, which are configured as shown. The customer's analog phones 180 and 190 are connected to the customer premises wiring 140, and a computer 195, which may, for example, be used for Internet access, is connected to the DSL modem 160. The battery 170 may be an uninterruptible power supply that may be used to provide power for the ATA 150, DSL modem 160, the analog phones 180 and 190, and/or the computer 195.

If a customer receives broadband service from something other than the DSL local loop 130, then the customer may wish to disconnect the customer premises wiring 140 from the NID 120 because both voice and data services would be provided via the broadband service provider and the local loop 130 would not be needed.

If, however, the customer receives broadband service via the DSL local loop 130 as shown in FIG. 1, then, typically, the customer premises wiring 140 is disconnected from the NID 120 to prevent the analog phones 180 and 190 from receiving POTS voice signals along with power (battery), dial tone, and power ringing from the central office 110. This is because the ATA 150 provides these functions as part of VoN service. The broadband connection for the VoN service is provided by the DSL local loop 130, however. Thus, a separate connection is normally made between the NID 120 and the DSL modem 160 to provide the DSL broadband connection for the VoN service. Unfortunately, setting up the connection between the NID 120 and the DSL modem 160 may involve considerable installation time and/or expense.

### SUMMARY OF THE INVENTION

According to some embodiments of the present invention, communications wiring at a customer premises location is connected to an outside plant loop using a high pass filter circuit.

In other embodiments of the present invention, the high pass filter circuit is used to substantially block signals associated with plain old telephone service (POTS).

In still other embodiments of the present invention, the high pass filter circuit is used to substantially block signals having a frequency up to about 4 kHz.

In still other embodiments of the present invention, the high pass filter circuit is used to substantially pass signals having frequencies associated with digital subscriber line (DSL) service.

In still other embodiments of the present invention, the wiring at the customer premises location is used to provide Voice over Network (VoN) service.

In still other embodiments of the present invention, it is detected that the VoN service is unavailable. The high pass filter circuit is bypassed to substantially pass the signals associated with POTS responsive to detecting that the VoN service is unavailable.

In still other embodiments of the present invention, a sealing current is generated on the outside plant loop. A sealing current termination circuit is used to terminate the sealing current at the customer premises location. The sealing current termination circuit may be incorporated as part of the high pass filter circuit.

In still other embodiments of the present invention, the sealing current termination circuit is incorporated as part of a network interface device (NID).

In still other embodiments of the present invention, the high pass filter circuit is incorporated as part of a network interface device (NID).

In still other embodiments of the present invention, a signature impedance is used to indicate a presence of the high pass filter circuit to a test system that is connected to the customer premises location via the outside plant loop.

In still other embodiments of the present invention, the signature impedance is incorporated as part of a network interface device (NID).

In still other embodiments of the present invention, the signature impedance is incorporated as part of the high pass filter circuit.

In still other embodiments of the present invention, a second loop is connected between the outside plant loop and the customer premises location such that the second loop is connected to the communications wiring at the customer premises location via the high pass filter circuit.

In still other embodiments of the present invention, a second line POTS service may be provided by making a second connection between the outside plant loop and the customer premises location such that this connection is directly connected to a separate copper pair of communications wiring at the customer premises location via the POTS separator circuit. Optionally, this connection can include a low pas filter to keep the high-frequency DSL signal from propagating to the premises wiring on the separate copper pair.

In still other embodiments of the present invention, the second loop is used to provide an alarm service.

Although described primarily above with respect to method aspects of the present invention, it will be understood that the present invention may also be embodied as electronic circuits.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional communication network in which Voice over Network (VoN) service uses a digital subscriber line (DSL) to provide broadband functionality;

FIG. 2 is a block diagram that illustrates a communication network in which a high pass filter is used to connect communication wiring at a customer premises location to an outside plant loop and methods of operating the same in accordance with some embodiments of the present invention; and

FIG. 3 is a schematic that illustrates a high pass filter and bypass circuit in accordance with some embodiments of the present invention.

### DETAILED DESCRIPTION OF EMBODIMENTS

While the present invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements. As used herein, the term “and/or” includes any and all combinations of one or more of the associated listed items. Like numbers refer to like elements throughout the description.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

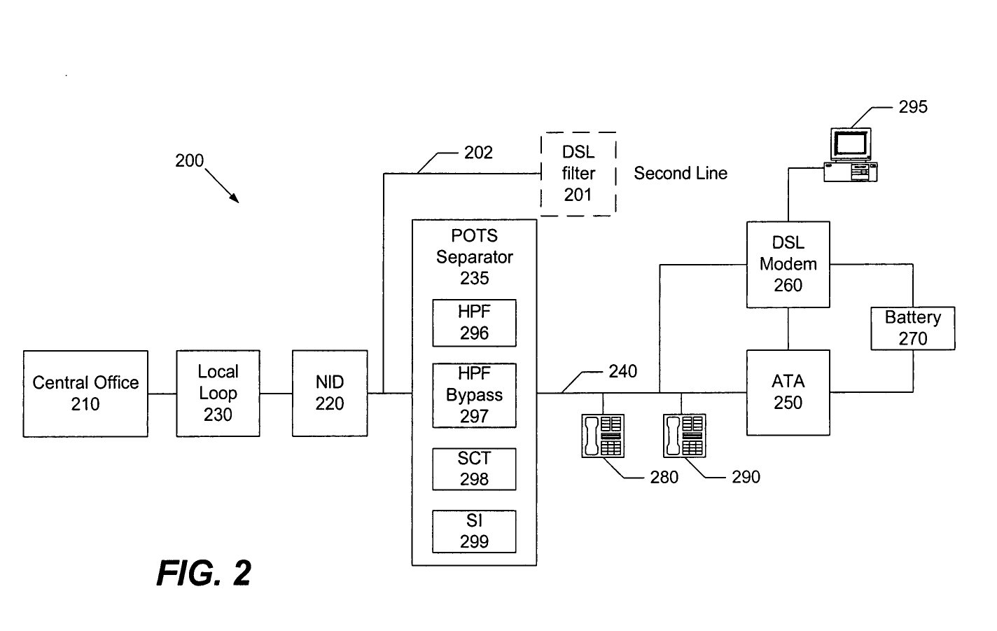

According to some embodiments of the invention shown in FIG. 2, a communication network 200 comprises a central office 210 that is connected to a network interface device (NID) 220 via an outside plant local loop 230. As discussed above, the NID 220, which is sometimes referred to as a network interface unit (NIU), serves as a point of demarcation between the local exchange carrier network and the customer's premise. The NID 220 may be a multi-functional device that includes a protector circuit to protect customer premise equipment from high-voltage surges. The NID 220 may also include functionality that allows the central office 210 to perform a loop-back test to check the integrity of the local loop 230. The local loop 230 may be a DSL line, which may provide broadband speeds over a conventional copper loop.

In addition to the NID 220, the customer premises includes a POTS separator circuit 235, customer premises wiring 240, an analog terminal adaptor (ATA) 250, a DSL modem 260, and a battery 270, which are configured as shown. The customer's analog phones 280 and 290 are connected to the customer premises wiring 240, and a computer 295, which may be used for Internet access, for example, is connected to the DSL modem 260. The battery 270 may be an uninterruptible power supply that may be used to provide power for the ATA 250, DSL modem 260, the analog phones 280 and 290, and/or the computer 295. The ATA 250 may provide such functionality as dial tone, battery, and power ringing as part of providing POTS functionality through a Voice over Network (VoN) service over the customer premises wiring 240.

The POTS separator circuit 235 comprises a high pass filter circuit 296 and, optionally, a high pass filter bypass circuit 297, a sealing current termination (SCT) circuit 298, and/or a signature impedance circuit 299 in accordance with various embodiments of the present invention. The high pass filter circuit 296 is used to connect the communications wiring 240 at the customer premises to the outside plant loop 230, i.e., a DSL line. The high pass filter circuit 296 may be configured to substantially block signals associated with POTS and to substantially pass signals having frequencies associated with DSL service. The Public Switched Telephone Network (PSTN) has been designed so as to limit the frequency spectrum allocated to POTS service to between direct current (DC) or zero Hertz and around 4 kHz. The local loop 230, however, is capable of carrying frequencies well beyond the upper limit of POTS service. Depending on the length and quality of the local loop, the upper limit can be as high as tens of megahertz. DSL technology takes advantage of this unused spectrum by allocating bandwidth for broadband applications at frequencies higher than the zero to about 4 kHz band that is allocated to POTS service.

Advantageously, by blocking the POTS voice signals along with battery, dial tone, and power ringing from the central office 210, the POTS service provided by the central office 210 does not conflict with the POTS service provided as part of the VoN service. That is, the ATA 250 may provide dial tone, battery, and power ringing for the analog phones 280 and 290. Moreover, the VoN service may provide POTS functionality over the outside plant local loop 230, i.e., the DSL line, without having to run a separate line from the NID 220 to the DSL modem 260. This is because the high pass filter 296 allows the DSL signals to pass between the customer premises wiring 240 and the local loop 230, while blocking the conflicting POTS signals.

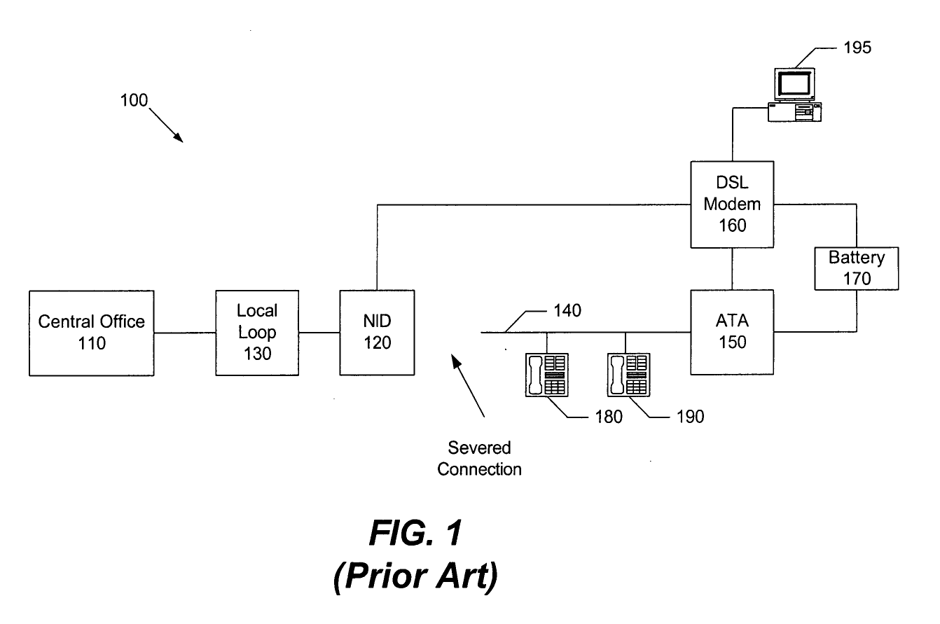

As shown in FIG. 1, the POTS separator circuit 235 may comprise a high pass filter bypass circuit 297. The high pass filter bypass circuit 297 may be configured to detect when the VoN service is unavailable by, for example, detecting a loss of power at the customer premises and/or the ATA 250 going out of service. If there is a loss of VoN service, then the high pass filter bypass circuit 297 may bypass the high pass filter circuit 296 so that signals associated with POTS service may now pass through the high pass filter circuit 296 between the customer premises wiring 240 and the outside plant local loop 230. Because the central office 210 is typically designed to be highly reliable, even if some of the elements supporting the VoN network goes down at the customer premises, e.g., the ATA 250, the customer may then be able to switch over to POTS service that is provided via the central office 210 without the need to perform any re-wiring at the customer premises location.

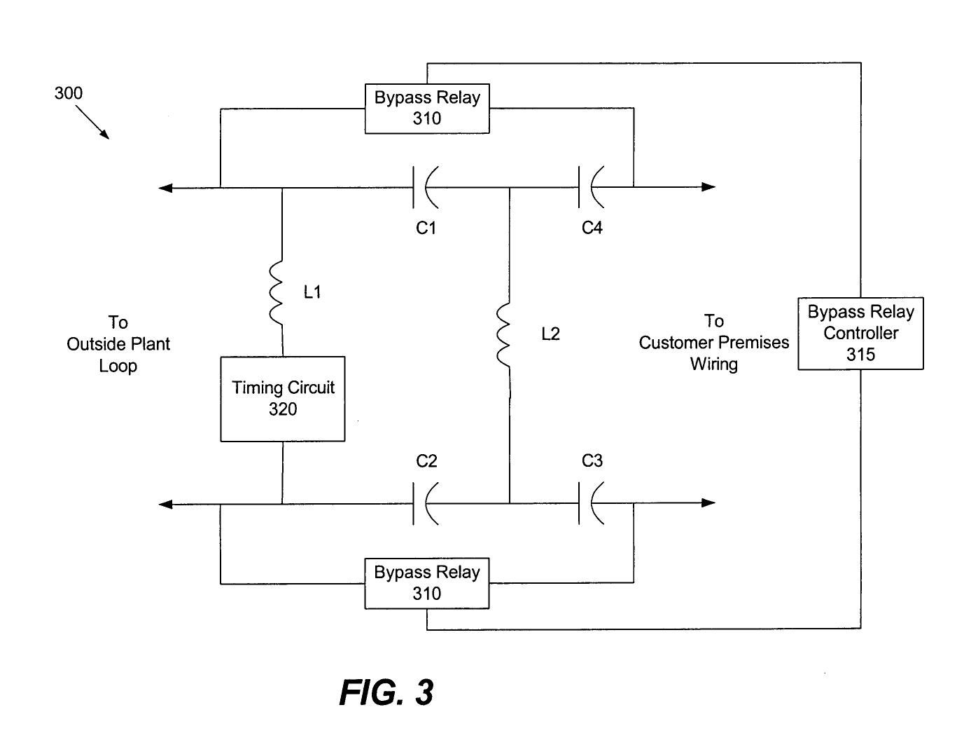

FIG. 3 is a schematic that illustrates a high pass filter and bypass circuit in accordance with some embodiments of the present invention. As shown in FIG. 3, the high pass filter and bypass circuit 300 comprises inductors L1 and L2 and capacitors C1, C2, C3, and C4 that are configured as shown. The high pass filter and bypass circuit 300 further comprises a bypass relay circuit 310 and a bypass relay controller 315, which are configured to detect when the VoN service is unavailable. In response to detecting that the VoN service is unavailable, the bypass relay controller 315 causes the bypass relay circuit 310 to bypass the high pass filter circuit 296 so that signals associated with POTS service now pass through the high pass filter circuit 296 between the customer premises wiring 240 and the outside plant local loop 230 as discussed above. The high pass filter and bypass circuit 300 may further comprise a timing circuit 320 that may be used to generate simulated off-hooks on a periodic basis so that maintenance processes at the central office 210, for example, do not attempt to take the local loop 230 out of service for maintenance due to extended inactivity.

Returning to FIG. 2, the POTS separator 235 may comprise a sealing current termination circuit 298 in accordance with some embodiments of the present invention. The sealing current termination circuit 298 may be used to sink a sealing current that is generated on the outside plant local loop 230 by the central office 210. The sealing current helps to reduce oxide corrosion in cable junctions and splices in the network.

The POTS separator circuit 235 may comprise a signature impedance circuit 299 in accordance with some embodiments of the present invention. The signature impedance may indicate the presence of the high pass filter 296 to a test system, for example, in the central office 210 or elsewhere that is connected to the customer premises via the local loop 230.

In accordance with various embodiments of the present invention, the high pass filter circuit 296, the high pass filter bypass circuit 297, the sealing current termination circuit 298, and the signature impedance circuit 299 may comprise part of a same circuit, may comprise separate circuits, or some of the circuits may be implemented as part of a same circuit and some of the circuits may be implemented separately. Moreover, any of the high pass filter circuit 296, the high pass filter bypass circuit 297, the sealing current termination circuit 298, and the signature impedance circuit 299 may be implemented as part of the NID 220.

Referring to FIG. 2, a second line 202 may be implemented as a second loop that taps into the wiring between the outside plant local loop 230 and the high pass filter 296. That is, the high pass filter 296 connects the second loop 202 to the customer premises wiring 240. Thus, if the high pass filter 296 is implemented as part of the NID 220, then the second loop taps into the wiring in the NID 220 between the high pass filter 296 and the outside plant local loop 230. The second loop 202 or line may be used to provide POTS service and/or DSL service in accordance with various embodiments of the present invention. In other words, a second line 202 POTS service may be provided by making a second connection between the outside plant loop and the customer premises location such that this connection is directly connected to a separate copper pair of communications wiring at the customer premises location via the POTS separator circuit 235. Optionally, this connection can include a low pas filter 201 to keep the high-frequency DSL signal from propagating to the premises wiring on the separate copper pair.

The second loop or line may also be used to provide an alarm service. The second loop or line may be desirable for providing an alarm service because it is powered through the generally reliable central office. Thus, the second loop or line may still provide POTS, DSL, and/or an alarm service during times when the VoN components, such as the ATA 250, at the customer premises are out of service due to a power outage or other problem.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. A method of operating a communication network, comprising:
connecting communications wiring at a customer premises location to an outside plant loop using a high pass filter circuit.

2. The method of claim 1, further comprising:
using the high pass filter circuit to substantially block signals associated with plain old telephone service (POTS).

3. The method of claim 2, wherein using the high pass filter comprises:
using the high pass filter circuit to substantially block signals having a frequency up to about 4 kHz.

4. The method of claim 2, wherein using the high pass filter comprises:
using the high pass filter circuit to substantially pass signals having frequencies associated with digital subscriber line (DSL) service.

5. The method of claim 4, further comprising:
using the wiring at the customer premises location to provide Voice over Network (VoN) service.

6. The method of claim 5, further comprising:
detecting that the VoN service is unavailable; and
bypassing the high pass filter circuit to substantially pass the signals associated with POTS responsive to detecting that the VoN service is unavailable.

7. The method of claim 1, further comprising:
generating a sealing current on the outside plant loop;
using a sealing current termination circuit to terminate the sealing current at the customer premises location; and
incorporating the sealing current termination circuit as part of the high pass filter circuit.

8. The method of claim 7, further comprising:
incorporating the sealing current termination circuit as part of a network interface device (NID).

9. The method of claim 1, further comprising:
incorporating the high pass filter circuit as part of a network interface device (NID).

10. The method of claim 1, further comprising:
using a signature impedance to indicate a presence of the high pass filter circuit to a test system that is connected to the customer premises location via the outside plant loop.

11. The method of claim 10, further comprising:
incorporating the signature impedance as part of a network interface device (NID).

12. The method of claim 10, further comprising:
incorporating the signature impedance as part of the high pass filter circuit.

13. The method of claim 1, further comprising:
connecting a second loop between the outside plant loop and the customer premises location such that the second loop is connected to the communications wiring at the customer premises location via the high pass filter circuit.

14. The method of claim 13, further comprising:
using the second loop to provide plain old telephone service (POTS) and/or digital subscriber line (DSL) service.

15. The method of claim 13, further comprising:
using the second loop to provide an alarm service.

16. The method of claim 1, wherein the communications wiring at the customer premises location has a Voice over Network (VoN) analog terminal adaptor connected thereto.

17. An electronic circuit, comprising:
a high pass filter circuit that is configured to connect communications wiring at a customer premises location to an outside plant loop.

18. The electronic circuit of claim 17, wherein the high pass filter circuit is configured to substantially block signals associated with plain old telephone service (POTS).

19. The electronic circuit of claim 18, wherein the high pass filter circuit is configured to substantially block signals having a frequency up to about 4 kHz.

20. The electronic circuit of claim 18, wherein the high pass filter circuit is configured to substantially pass signals having frequencies associated with digital subscriber line (DSL) service.

21. The electronic circuit of 20, wherein the wiring at the customer premises location is configured to provide Voice over Network (VoN) service.

22. The electronic circuit of claim 21, further comprising:
a bypass circuit that is configured to detect that the VoN service is unavailable and to substantially pass the signals associated with POTS responsive to detecting that the VoN service is unavailable.

23. The electronic circuit of claim 17, further comprising:
a sealing current termination circuit that is configured to terminate a sealing current that is generated on the outside plant loop.

24. The electronic circuit of claim 17, further comprising:
a signature impedance that is configured to indicate a presence of the high pass filter circuit to a test system that is connected to the customer premises location via the outside plant loop.

25. The electronic circuit of claim 17, wherein a second loop is connected between the outside plant loop and the customer premises location, and wherein the second loop is connected to the communications wiring at the customer premises location via the high pass filter circuit.

26. The electronic circuit of claim 25, wherein the second loop is configured to provide plain old telephone service (POTS) and/or digital subscriber line service (DSL).

27. The electronic circuit of claim 25, further comprising a DSL filter connected to the second loop.

28. The electronic circuit of claim 25, wherein the second loop is configured to provide an alarm service.

29. The electronic circuit of claim 17, wherein the communications wiring at the customer premises location has a Voice over Network (VoN) analog terminal adaptor connected thereto.
